(19) United States
(12) Patent Application Publication
(10) Pub. No.: US 2026/0128217 A1
(43) Pub. Date: May 7, 2026

(54) MULTILAYER ELECTRONIC COMPONENT

(71) Applicant: SAMSUNG ELECTRO-MECHANICS CO., LTD., Suwon-si (KR)

(72) Inventors: Ji Hun LEE, Suwon-si (KR); Sang Yeop KIM, Suwon-si (KR); Tae Yong KIM, Suwon-si (KR)

(73) Assignee: SAMSUNG ELECTRO-MECHANICS CO., LTD., Suwon-si (KR)

(21) Appl. No.: 19/247,864

(22) Filed: Jun. 24, 2025

(30) Foreign Application Priority Data
Nov. 6, 2024 (KR) 10-2024-0156140

(51) Int. Cl. H01G 4/005; H01G 4/30

(52) U.S. Cl. CPC H01G 4/005; H01G 4/30

(57) ABSTRACT

A multilayer electronic component includes a body having first and second surfaces opposing each other in a first direction, third and fourth surfaces opposing each other, and fifth and sixth surfaces opposing each other. The body includes an overlap region with a dielectric layer and internal electrodes alternately disposed in the first direction, a first margin region between the overlap region and the third surface, and a second margin region between the overlap region and the fourth surface. First and second external electrodes are disposed on the third and fourth surfaces, respectively. First and second through-hole electrodes penetrate the first and second margin regions, respectively. 3%≤R1≤7% and/or 3%≤R2≤7% is satisfied, where R1 and R2 represent ratios of areas of the first and second through-hole electrodes to areas of the first and second margin regions, respectively, in a cross-section of the body.

### CROSS-REFERENCE TO RELATED APPLICATION(S)

This application claims the benefit of priority to Korean Patent Application No. 10-2024-0156140 filed on Nov. 6, 2024 with the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic products, such as image display devices including a liquid crystal display LCD and a plasma display panel PDP, computers, smartphones and mobile phones, and serves to charge or discharge electricity therein or therefrom. Such multilayer ceramic capacitors may be used as a component in various electronic devices due to having a small size, ensuring high capacitance and being easily mounted.

Recently, as the performance of electronic products mounted with MLCCs has improved, higher capacitance and uniform capacitance implementation of MLCCs are required. However, capacitance distribution and ESR distribution may occur due to poor contact between the internal and external electrodes of the MLCC. To solve these problems, there is a method of making holes in the body and disposing via electrodes connecting internal electrodes of the same polarity.
(Patent document 1) Japanese Patent No. 2004-281957

### SUMMARY

An aspect of the present disclosure is to provide a multilayer electronic component having excellent electrical characteristics.

However, problems to be solved by the present disclosure are not limited to the above, and will be more easily understood in the process of describing specific embodiments of the present disclosure.

A multilayer electronic component according to an embodiment of the present disclosure may comprise: a body including a first surface and a second surface opposing each other in a first direction, and connected to the first and second surfaces, a third surface and a fourth surface connected to the first and second surfaces and opposing each other in a second direction, a fifth surface and a sixth surface connected to the first to fourth surfaces and opposing each other in a third direction, the body including an overlap region including a dielectric layer and a first internal electrode and a second internal electrode alternately disposed in the first direction with the dielectric layer therebetween, a first margin region disposed between the overlap region and the third surface, wherein the second internal electrode does not exist, and a second margin region disposed between the overlap region and the fourth surface, wherein the first internal electrode does not exist, first and second external electrodes disposed on the third and fourth surfaces respectively and connected to the first and second internal electrodes respectively, and first and second through-hole electrodes penetrating the first and second margin regions respectively and connected to the first and second internal electrodes respectively, wherein the multilayer electronic component satisfies at least one of 3%≤R1≤7% and 3%≤R2≤7%, where R1 is a ratio of an area of the first through-hole electrode to an area of the first margin region, and R2 is a ratio of an area of the second through-hole electrode to an area of the second margin region in a cross section of the body in the second and third directions.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure.

FIG. 2 schematically illustrates a cross-sectional view taken along line I-I′ of FIG. 1.

FIG. 3 schematically illustrates a cross-sectional view taken along line II-II′ of FIG. 1.

FIG. 4 schematically illustrates a cross-sectional view taken along line III-III′ of FIG. 2.

FIG. 5 is a cross-sectional view of FIG. 4 with an internal electrode and a penetrating electrode removed, schematically illustrating the area of a margin region.

FIG. 6 is a cross-sectional view of FIG. 4 with an internal electrode removed, schematically illustrating the area of a through-hole electrode.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawing, a first direction X may be defined as a thickness direction T, a second direction Y may be defined as a length direction L, and a third direction Z may be defined as a width direction W.

### Multilayer Electronic Component

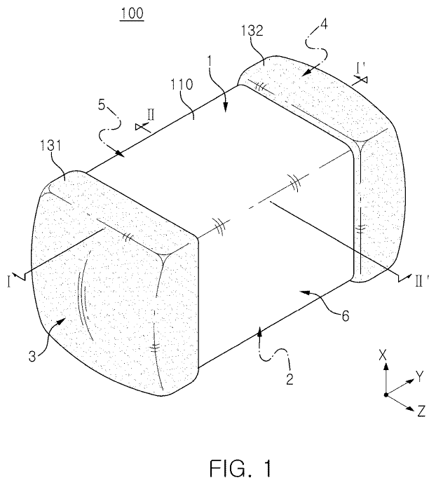

FIG. 1 is a perspective view schematically illustrating a multilayer electronic component according to an embodiment of the present disclosure.

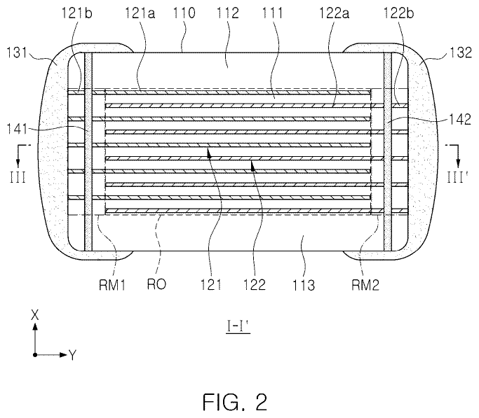

FIG. 2 schematically illustrates a cross-sectional view taken along line I-I′ of FIG. 1.

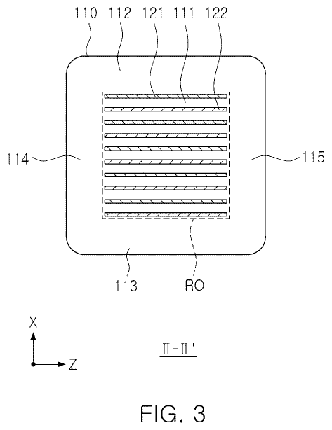

FIG. 3 schematically illustrates a cross-sectional view taken along line II-II′ of FIG. 1.

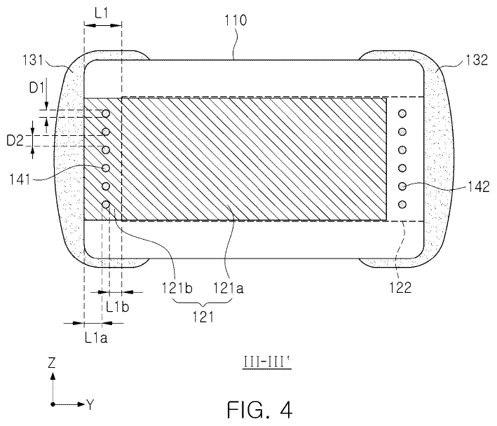

FIG. 4 schematically illustrates a cross-sectional view taken along line III-III′ of FIG. 2.

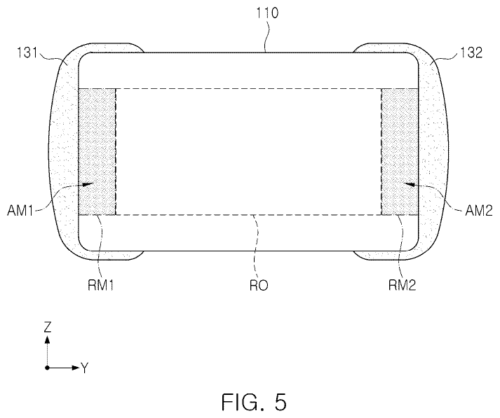

FIG. 5 is a cross-sectional view of FIG. 4 with an internal electrode and a penetrating electrode removed, schematically illustrating the area of a margin region.

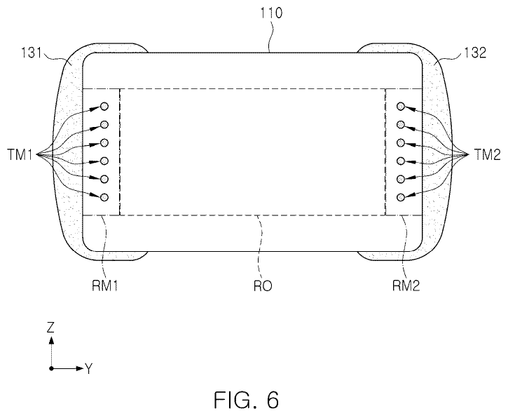

FIG. 6 is a cross-sectional view of FIG. 4 with an internal electrode removed, schematically illustrating the area of a through-hole electrode.

Hereinafter, a multilayer electronic component 100 according to an embodiment of the present disclosure will be described in detail with reference to FIGS. 1 to 6. In addition, as an example of a multilayer electronic component, a multilayer ceramic capacitor is described, but the present disclosure is not limited thereto and may also be applied to various multilayer electronic components, such as inductors, piezoelectric elements, varistors, or thermistors.

A multilayer electronic component 100 according to an embodiment of the present disclosure may include a body 110 including a dielectric layer 111 and internal electrodes 121 and 122, external electrodes 131 and 132, and through-hole electrodes 141 and 142.

There is no particular limitation on the specific shape of the body 110, but as illustrated, the body 110 may have a hexahedral shape or a shape similar thereto. Due to shrinkage of ceramic powder particles included in the body 110 during a sintering process or due to the polishing process for corner portions of the body 110, the body 110 may not have a hexahedral shape with entirely straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

The body 110 may include the dielectric layer 111 and the internal electrodes 121 and 122 disposed alternately with the dielectric layer 111. A plurality of dielectric layers 111 is in a sintered state, such that boundaries between adjacent dielectric layers 111 may be integrated so as to be difficult to identify without using a scanning electron microscope (SEM).

The dielectric layer 111 may include, for example, a perovskite-type compound represented by ABO₃ as a main component. The perovskite-type compound represented by ABO₃ may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and (Ca₁₋ₓSrₓ) (Zr_{1-y}Ti_{y})O₃ (0≤x≤0.5, 0≤y≤0.5).

An average thickness of the dielectric layer 111 is not particularly limited. The average thickness of the dielectric layer 111 may be, for example, 0.1 μm to 20 μm, 0.1 μm to 10 μm, 0.1 μm to 5 μm, 0.1 μm to 2 μm, or 0.1 μm to 0.4 μm.

The first internal electrode 121 and the second internal electrode 122 may be alternately disposed in the first direction X with the dielectric layer 111 interposed therebetween. That is, the first internal electrode 121 and the second internal electrode 122, a pair of electrodes having different polarities, may be disposed opposing each other with the dielectric layer 111 therebetween. The first and second internal electrodes 121 and 122 may be electrically separated from each other by the dielectric layer 111 disposed therebetween.

The first internal electrode 121 may be spaced apart from the fourth surface 4 and may be connected to the first external electrode 131 on the third surface 3. The second internal electrode 122 may be spaced apart from the third surface 3 and may be connected to the second external electrode 132 on the fourth surface 4.

A conductive metal included in the internal electrode 121 and 122 may be one or more of Ni, Cu, Pd, Ag, Au, Pt, Sn, W, Ti, and alloys thereof, and more preferably, the internal electrode 121 and 122 may include Ni, but the present disclosure is not limited thereto.

An average thickness of the internal electrodes 121 and 122 is not particularly limited. The average thicknesses of the internal electrode 121 and 122 may be, for example, 0.1 μm to 10.0 μm, 0.1 μm to 3.0 μm, 0.1 μm to 1.0 μm, or 0.1 μm to 0.4 μm.

The average thickness of the dielectric layer 111 and the average thickness of the internal electrodes 121 and 122 respectively refers to average thicknesses of the dielectric layer 111 and the internal electrodes 121 and 122 in the first direction X. The average thickness of the dielectric layer 111 and the average thickness of the internal electrodes 121 and 122 may be measured by scanning cross-sections of the body 110 in the first and second direction with a scanning electron microscope SEM of 10,000× magnification. More specifically, the average thickness of the dielectric layer 111 may be measured by calculating the average after measuring the thickness at a plurality of points of one dielectric layer 111, for example, at 5 points equally spaced apart from each other in the second direction, and then taking the average value. In addition, the average thicknesses of the internal electrodes 121 and 122 may be measured by calculating the average after measuring the thicknesses at a plurality of points of one internal electrode 121 and 122, for example, at 5 points equally spaced apart from each other in the second direction. The 10 points equally spaced apart from each other may be designated in an overlap region RO. When the average value measurements are performed for each of 10 dielectric layers 111 and 10 internal electrodes 121 and 122, and then the average values are calculated, the average thickness of the dielectric layer 111 and the average thicknesses of the internal electrodes 121 and 122 may be further generalized.

The body 110 may be disposed inside the body 110, and may include the overlap region RO in which capacitance is formed, including the dielectric layer 111 and the first and second internal electrodes 121 and 122 alternately disposed in the first direction with the dielectric layer therebetween, a first margin region RM1 disposed between the overlap region RO and the third surface 3 and in which the second internal electrode 122 does not exist, and a second margin region RM2 disposed between the overlap region RO and the fourth surface 4 and in which the first internal electrode 121 does not exist. That is, margin regions RM1 and RM2 may be disposed on both surfaces of the overlap region RO opposing each other in the second direction Y.

The first internal electrode 121 may include a first main portion 121a disposed in the overlap region RO and overlapping the second internal electrode 122 in the first direction X, and a first lead portion 121b disposed in the first margin region RM1 and extending from the first main portion 121a and exposed to the third surface 3. That is, the first margin region RM1 may refer a region where a plurality of the first lead portions 121b overlapping without interposing the second internal electrode 122 in the first direction X.

The second internal electrode 122 may include a second main portion 122a disposed in the overlap region RO and overlapping the first internal electrode 121 in the first direction X, and a second lead portion 122b disposed in the second margin region RM2 and extending from the second main portion 122a and exposed to the fourth surface 4. That is, the second margin region RM2 may refer to a region where a plurality of the second lead portions 122b overlapping without interposing the first internal electrode 121 in the first direction X.

Meanwhile, in the drawing, a width of the lead portions 121b and 122b in the third direction Z is illustrated as being the same as a width of the main portions 121a and 122a in the third direction Z, but the present disclosure is not limited thereto. For example, the width of the lead portions 121b and 122b in the third direction Z may be greater or less than the width of the main portions 121a and 122a in the third direction Z. In addition, the width of the lead portions 121b and 122b in the third direction Z may gradually be greater or smaller from the main portions 121a and 122a to the third 3 or fourth 4 surfaces.

The body 110 may include a first cover portion 112 and a second cover portion 113 disposed on both surfaces of the overlap region RO opposing each other in the first direction X. The first cover portion 112 may be sequentially disposed on one surface of the overlap region RO in the first direction X, one surface of the first margin region RM1 in the first direction X, and one surface of the second margin region RM2 in the first direction X. The second cover portion 113 may be sequentially disposed on the other surface of the overlap region RO in the first direction X, the other surface of the first margin region RM1 in the first direction X, and the other surface of the second margin region RM2 in the first direction X. The cover portions 112 and 113 may have a similar configuration to the dielectric layer 111 except for not including internal electrodes.

An average thicknesses of the cover portions 112 and 113 may not be particularly limited. The average thickness of the cover portions 112 and 113 may be, for example, 300 μm or less, 100 μm or less, 30 μm or less, or 20 μm or less. The average thickness of the cover portions 112 and 113 may be, for example, 5 μm or more, 10 μm or more, or 20 μm or more. The average thicknesses of the cover portions 112 and 113 may refer to an average thickness of each of the first cover portion 112 and the second cover portion 113.

The average thickness of the cover portions 112 and 113 may refer to an average thickness of the cover portions 112 and 113 in the first direction X, and may be an average value of the thicknesses in the first direction X measured at 5 points equally spaced apart from each other in a cross-section of the body 110 in the first and second directions.

The body 110 may include a first side portion 114 and a second side portion 115 respectively disposed on both surfaces of the overlap region RO opposing each other in the third direction. The first side portion 114 may be sequentially disposed on one surface of the overlap region RO in the third direction, one surface of the first margin region RM1 in the third direction, and one surface of the second margin region RM2 in the third direction. The second side portion 115 may be sequentially disposed on the other surface of the overlap region RO in the third direction, the other surface of the first margin region RM1 in the third direction, and the other surface of the second margin region RM2 in the third direction. That is, the side portions 114 and 115 may refer to a region between both ends of the internal electrodes 121 and 122 and a boundary surface of the body 110 in a cross-section of the body 110 cut in the first direction and the third direction. The side portions 114 and 115 may have a similar configuration to the dielectric layer 111 except for not including internal electrodes 121 and 122.

An average thickness of the side portions 114 and 115 may not be particularly limited. The average thickness of the side portions 114 and 115 may be, for example, 100 μm or less, 20 μm or less, or 15 μm or less. The average thickness of the side portions 114 and 115 may be, for example, 5 μm or more, or 10 μm or more. The average thickness of the side portions 114 and 115 may refer to an average thickness of each of the first side portion 114 and the second side portion 115.

The average thickness of the side portions 114 and 115 may refer to an average thickness of the side portions 114 and 115 in the third direction Z, and may be an average value of the average thicknesses in the third direction Z measured at 5 points equally spaced apart from each other in a cross-section of the body 110 in the first and third directions.

External electrodes 131 and 132 may be disposed on the third and fourth surfaces 3 and 4. For example, the first external electrode 131 may be disposed on the third surface 3 and connected to the first internal electrode 121, and the second external electrode 132 may be disposed on the fourth surface 4 and connected to the second internal electrode 122. The first external electrode 131 may be disposed to extend from the third surface 3 to the first and second surfaces 1 and 2, and the second external electrode 132 may be disposed to extend from the fourth surface 4 to the first and second surfaces 1 and 2. In addition, the first and second external electrodes 131 and 132 may be disposed to extend onto the fifth and sixth surfaces 5 and 6.

Types or shapes of the external electrodes 131 and 132 may not be particularly limited, and may have a multilayer structure. For example, the external electrodes 131 and 132 may include base electrode layer in contact with the internal electrodes 121 and 122 and plating layer disposed on the base electrode layer.

The base electrode layer may be sintered electrode layer including metal and glass. The metal included in the sintered electrode layer may include, for example, Cu, Ni, Pd, Pt, Au, Ag, Pb and/or alloys thereof. The glass included in the sintered electrode layer may include, for example, one or more oxides of Ba, Ca, Zn, Al, B, and Si. However, the present disclosure is not limited thereto.

The base electrode layer may be configured by only the sintered electrode layer including metal and glass, but the present disclosure may not be limited thereto, and the base electrode layer may have a multilayer structure. The base electrode layer may include, for example, a sintered electrode layer including metal and glass, and a resin electrode layer disposed on the sintered electrode layer and including metal particles and resin.

The metal particles included in the resin electrode layer may include one or more of spherical particles and flake-shaped particles. The metal included in the resin electrode layer may include, for example, Cu, Ni, Pd, Pt, Au, Ag, Pb, Sn and/or alloys thereof. The resin included in the resin electrode layer may include, for example, one or more of epoxy resin, acrylic resin, and ethyl cellulose.

The plating layer may include, for example, Ni, Sn, Pd and/or alloys thereof, and may be formed of a plurality of layers. The plating layer may be, for example, Ni plating layer or Sn plating layer, and may also be in the form in which the Ni plating layer and the Sn plating layer are formed sequentially thereon. Additionally, the plating layer may include a plurality of Ni plating layers and/or a plurality of Sn plating layers.

Although the drawing describes a structure in which a multilayer electronic component 100 has two external electrodes 131 and 132, it may not be limited thereto, and the number or shape of the external electrodes 131 and 132 may be changed depending on the shape of the internal electrodes 121 and 122 or other purposes.

The multilayer electronic component 100 may include a first through-hole electrode 141 penetrating the first margin region RM1 and may be connected to the first internal electrode 121, and a second through-hole electrode 142 penetrating the second margin region RM2 and may be connected to the second internal electrode 122.

The first through-hole electrode 141 may be disposed to be connected to a plurality of first lead portions 121b but spaced apart from the second internal electrode 122, and the second through-hole electrode 142 may be disposed to be connected to a plurality of second lead portions 122b but spaced apart from the first internal electrode 121.

The through-hole electrodes 141 and 142 may stably connect a plurality of internal electrodes 121 and 122. That is, even a portion of the internal electrodes 121 and 122 may not be in contact with the external electrodes 131 and 132 on the third 3 or fourth surface 4 due to shrinkage or poor polishing during the sintering process, the internal electrodes 121 and 122 may be electrically connected to the external electrodes 131 and 132 through the through-hole electrodes 141 and 142 and the internal electrodes 121 and 122 of a different layer. Therefore, capacitance and ESR characteristics of the multilayer electronic component 100 may be improved.

Although the through-hole electrodes 141 and 142 do not necessarily have to be in contact with the external electrodes 131 and 132, in order to more stably secure an electrical connection between the internal electrodes 121 and 122 and the external electrodes 131 and 132, the first through-hole electrode 141 may be exposed to the first 1 and second surfaces 2, and connected to the first external electrode 131, and the second through-hole electrode 142 may be exposed to the first 1 and second surfaces 2, and connected to the second external electrode 132.

According to an embodiment of the present disclosure satisfies one or more of 3%≤R1≤7% and 3%≤R2≤7%, where R1 is a ratio of the area of the first through-hole electrode 141 to the area of the first margin region RM1, and R2 is a ratio of the area of the second through-hole electrode 142 to the area of the second margin region RM2, in the cross-section of the body 110 in the second direction Y and third direction Z. More preferably, both of 3%≤R1≤7% and 3%≤R2≤7% may be satisfied.

When the R1 and/or R2 are less than 3%, the effect of improving capacitance and ESR characteristics by the through-hole electrodes 141 and 142 may be insignificant. Meanwhile, in order to form the through-hole electrodes 141 and 142, a hole must be machined in the body 110, but there may be a risk that cracks may occur in the body 110 during a hole-machining process. In particular, when the R1 and/or R2 exceed 7%, a side effect of cracks occurring in the body 110 may significantly appear.

The number of the through-hole electrodes 141 and 142 is not particularly limited, but each of a plurality of the first and second through-hole electrodes 141 and 142 may be disposed. The first and second through-hole electrodes 141 and 142 may each be disposed, for example, three or more. For example, a plurality of the first through-hole electrodes 141 may be arranged in the third direction Z, and a plurality of the second through-hole electrodes 142 may be arranged in the third direction Z. In this case, an area of the first through-hole electrode 141 may be a total area of the plurality of the first through-hole electrodes 141, and an area of the second through-hole electrode 142 may be the total area of the plurality of second through-hole electrodes 142.

In detail, referring to FIGS. 5 and 6, R1 may refer to a total area TM1 of the plurality of the first through-hole electrodes for an area AM1 of the first margin region, and R2 may refer a total area TM2 of the plurality of the second through-hole electrodes for an area AM2 of the second margin region.

The R1 and R2 may be measured, for example, by analyzing images taken with an optical microscope of the cross-section of the body 110 in the second direction Y and third direction Z. The overlap region RO and the margin regions RM1 and RM2 may be distinguished by the difference in brightness in an image captured by an optical microscope, and a region where the through-hole electrodes 141 and 142 are disposed and a region where the through-hole electrodes 141 and 142 are not disposed among the margin regions RM1 and RM2 may also be distinguished by the difference in brightness. The cross-section of the body 110 in the second direction Y and third direction Z may be a cross-section passing through the overlap region RO, and may be, for example, a cross-section in the second direction Y and third direction Z polished to the center of the body 110 in the first direction X.

In an embodiment, when a length of the first margin region RM1 in the second direction Y is L1, and a distance between the third surface 3 and the first through-hole-electrode 141 in the second direction Y is L1a, a ratio of L1a to L1 (L1a/L1) may be 5% or more. When L1a/L1 is less than 5%, there is a risk that cracks may occur as the first through-hole-electrode 141 and the third surface 3 of the body 110, are too close. A maximum limit of L1a/L1 is not particularly limited, but there may be a risk of a short circuit when the first through-hole electrode 141 and the second internal electrode 122 become too close. Thus, L1a/L1 to be 50% or less may be desirable.

In an embodiment, when a distance between the overlap region RO and the first through-electrode 141 in the second direction Y is L1b, a ratio of L1b to L1 (L1b/L1) may be 5% or more. When L1b/L1 is less than 5%, there may be a risk that a short circuit may occur because the first through-hole-electrode 141 and the second internal electrode 122 are too close. The maximum limit of L1b/L1 is not particularly limited, but there may be a risk of cracks occur when the first through-hole electrode 141 and the third surface 3 become too close. Thus, L1b/L1 to be 45% or less may be desirable.

In an embodiment, when a diameter of the first through-hole electrode 141 is D1, D1 may be 5 μm or more. When D1 is less than 5 μm, an effect of improving the capacitance and ESR characteristics by the first through-hole electrode 141 may be insignificant. A maximum limit of D1 is not particularly limited and may be, for example, 0.9×L1 or less. Alternatively, to prevent cracks occurring, D1 may be 0.5×L1 or less.

In an embodiment, when a distance between a plurality of the first through-hole electrodes 141 is D2, a ratio of D2 to D1 (D2/D1) may be 1.2 or more. When D2/D1 is less than 1.2, the distance between the first through-electrodes 141 is too close, a risk of cracks may occur between holes. A maximum limit of D2/D1 is not particularly limited, but may be, for example, 2.5 or less. When D2/D1 exceeds 2.5, the capacitance and ESR characteristic improvement effect by the through-hole-electrodes 141 and 142 may be insignificant.

Meanwhile, aside from the difference that the first through-hole electrode 141 is connected to the first internal electrode 121, and the second through-hole electrode 142 is connected to the second internal electrode 122, the first through-hole electrode 141 and the second through-hole electrode 142 may be in substantially symmetrical relationship with each other. Therefore, the description of L1a/L1, L1b/L1, D1, and D2/D1, or the like, may be equally applied to the second margin region RM2 and the second through-hole-electrode 142.

The shape of the through-electrodes 141 and 142 is not particularly limited, but the cross-sections of the through-hole-electrodes 141 and 142 may be circular, triangular, or square. However, in order to prevent cracks occurring, the cross-sections of the through-hole-electrodes 141 and 142 may be desirably triangular rather than square, and more desirably circular. That is, in an embodiment, in the cross-section of the body 110 in the second direction Y and third direction Z, cross-sections of the first and second through-hole-electrodes 141 and 142 may be circular.

Hereinafter, an example of a method for forming a multilayer electronic component 100 will be described. However, the manufacturing method of the multilayer electronic component 100 is not limited thereto.

First of all, ceramic powder for forming a dielectric layer 111 is prepared. The ceramic powder may include, for example, BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<y<1) or (Ca₁₋ₓSrₓ) (Zr_{1-y}Ti_{y})O₃ (0≤x≤0.5, 0≤y≤0.5). BaTiO₃ powder may be synthesized, for example, by reacting a titanium raw material such as titanium dioxide with a barium raw material such as barium carbonate. A synthesizing method of the ceramic powder may include methods, for example, a solid phase method, a sol-gel method, a hydrothermal synthesis method, or the like, but the present disclosure may not be limited thereto. Next, the prepared ceramic powder are dried and ground, and then an organic solvent such as ethanol and a binder such as polyvinyl butyral, are mixed to prepare a ceramic slurry, and then the ceramic slurry is applied and dried on a carrier film to prepare a ceramic green sheet.

Next, conductive paste for an internal electrode containing metal powder, binder, organic solvent, or the like is printed onto the ceramic green sheet with a predetermined thickness using a screen printing method or a gravure printing method, thereby forming an internal electrode pattern.

Thereafter, the ceramic green sheet having the internal electrode pattern printed thereon is peeled off from the carrier film, and then the ceramic green sheet having the internal electrode pattern printed in a predetermined amount of layers is laminated and pressed to form ceramic laminate. On the upper and lower portions of the ceramic laminate, a ceramic green sheet forming a cover portion without an internal electrode pattern, may be laminated in a predetermined amount of layers to form the cover portion 112 and 113 after sintering. Thereafter, the ceramic laminate is cut to have a predetermined size of a chip, and the cut chip may be sintered at a temperature of 1000° C. or higher and 1400° C. or lower to form the body 110.

Meanwhile, the side portions 114 and 115 may be formed by applying and sintering a conductive paste for internal electrodes on a ceramic green sheet except for a location where the side portions 114 and 115 are to be formed. Alternatively, in order to suppress a step difference by the internal electrodes 121 and 122, the ceramic laminate may be cut so that the internal electrode pattern is exposed on both surfaces of the cut chip in the third direction, and then a sheet for forming the side portion may be attached on both surfaces of the cut chip in the third direction and then sintered to form the side portions 114 and 115.

Next, hole processing is performed on the body 110. The hole processing may be formed by mechanical drilling of the body 110 or by irradiating a CO2 laser, but the present disclosure is not limited thereto. Thereafter, the through-hole electrodes 141 and 142 may be formed by filling the formed hole with a conductive paste.

Thereafter, external electrodes 131 and 132 may be formed on the body 110 on which the through-hole electrodes 141 and 142 are formed. The method of forming the external electrodes 131 and 132 is not particularly limited.

For example, when the external electrodes 131 and 132 include a sintered electrode layer, the body 110 may be dipped in an external electrode paste including metal powder, glass frit, binder, and an organic solvent, and then the external electrode paste may be sintered at a temperature of 500° C. to 900° C. to form a sintered electrode layer.

For example, when the external electrodes 131 and 132 include a resin electrode layer, the body may be dipped in a conductive resin composition including metal powder, resin, binder, and organic solvent, followed by curing heat treatment at a temperature of 250° C. to 550° C. to form the resin electrode layer.

In addition, an electrolytic plating method and/or an electroless plating method may be additionally performed to form a plating layer on the sintered electrode layer or the resin electrode layer.

### EXAMPLE

After preparing a sample chip of size 1005 (length: approximately 1.0 mm, width: approximately 0.5 mm, thickness: approximately 0.5 mm) through the above-mentioned method for manufacturing a multilayer electronic component, the electrical characteristics according to R1 and R2 were evaluated. R1 and R2 were measured from images of cross-sections in the second and third direction, polished to half of the sample chip in the first direction observed with an optical microscope. Sample number 1 was a sample chip without a through-hole electrode.

Capacitance evaluation was performed by measuring an average capacitance of each sample number using capacitance meter for a total of 10 sample chips for each specimen number, based on a target capacitance value of 15 μF, the relative value was represented as % and is listed in Table 1 below.

ESR evaluation was measured using an LCR meter (frequency: 500 kHz, SMD Fixture type probe), and ESR was measured in a total of 10 sample chips for each specimen number, and an average value is listed in Table 1 below.

When crack evaluation was performed by measuring the cross-sections of a total of 10 sample chips by specimen number using an optical microscope, if no sample chips had cracks, it was evaluated as excellent (o), if 3 or fewer sample chips had cracks, it was evaluated as good (Δ), and if more than 3 sample chips had cracks, it was evaluated as poor (X), and the results are listed in Table 1 below.

A final evaluation was conducted by taking all characteristics into consideration and evaluating them as excellent (VG), good (G), or poor (B), and is listed in Table 1 below.

TABLE 1

| Sample | R1 | Capacitance | ESR | Crack | Final |
|---|---|---|---|---|---|
| Number | (R2) | (%) | (mΩ) | Evaluation | Evaluation |
| 1 | 0% | 65.5 | 6.74 | ◯ | B |
| 2 | 1% | 66.7 | 5.97 | ◯ | B |
| 3 | 3% | 91.6 | 3.87 | ◯ | VG |
| 4 | 5% | 93.4 | 3.43 | ◯ | VG |
| 5 | 7% | 94.1 | 3.37 | Δ | G |
| 6 | 10% | 93.3 | 3.45 | X | B |

The capacitance values of sample numbers 1 and 2 are approximately 60% of the target capacitance value, and it can be confirmed that the capacitance value rapidly increases to more than 90% of the target capacitance value when R1 (R2) satisfies 3% or more. As R1 (R2) increases from 3% to 7%, the capacitance characteristics may improve, but the capacitance values may be converged when R1 (R2) exceeds 7%.

The ESR values of sample numbers 1 and 2 are approximately 6 mΩ, and it may be confirmed that the ESR may rapidly decrease to approximately 3 mΩ when R1 (R2) satisfies 3% or more. Additionally, it may be confirmed that ESR may decrease as R1 (R2) increases from 3% to 7%, but the ESR value may be converged when R1 (R2) exceeds 7%.

Meanwhile, it may be confirmed that cracks do not occur at all when R1 (R2) is within the range of 1% to 5%, but cracks occur when R1 (R2) is 7% or higher.

From this, it may be confirmed that when R1 and/or R2 are 3% or more and 7% or less, the electrical characteristics and reliability of the laminated electronic component are significantly improved.

The present disclosure is not limit the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the term “connected” includes not only direct connection but also indirect connection through an adhesive layer or the like. Additionally, the term electrically connected includes both physically connected and not physically connected. The terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of right of the example embodiments.

As one of the various effects of the present disclosure, a multilayer electronic component with excellent reliability can be provided.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including first and second surfaces opposing each other in a first direction, third and fourth surfaces connected to the first and second surfaces and opposing each other in a second direction, and fifth and sixth surfaces connected to the first to fourth surfaces and opposing each other in a third direction, the body including an overlap region including a dielectric layer and first and second internal electrodes alternately disposed in the first direction with the dielectric layer interposed therebetween, a first margin region disposed between the overlap region and the third surface, where the second internal electrode does not exist, and a second margin region disposed between the overlap region and the fourth surface, where the first internal electrode does not exist;
first and second external electrodes respectively disposed on the third and fourth surfaces and connected to the first and second internal electrodes, respectively; and
first and second through-hole electrodes penetrating the first and second margin regions respectively and connected to the first and second internal electrodes respectively;
at least one of 3%≤R1≤7% and 3%≤R2≤7% is satisfied, where R1 is a ratio of an area of the first through-hole electrode to an area of the first margin region, and R2 is a ratio of an area of the second through-hole electrode to an area of the second margin region in a cross section of the body in the second and third directions.

2. The multilayer electronic component of claim 1, wherein the first and second through-hole electrodes comprises a plurality of through-hole electrodes,
wherein the area of the first through-hole electrode is a total area of a plurality of the first through-hole electrodes,
wherein the area of the second through-hole electrode is a total area of a plurality of the second through-hole electrodes.

3. The multilayer electronic component of claim 2, wherein the plurality of the first through-hole electrodes are arranged in the third direction,
wherein the plurality of second through-hole electrodes are arranged in the third direction.

4. The multilayer electronic component of claim 1, wherein a ratio of L1a to L1 (L1a/L1) is 5% or more, where L1 is a length of the first margin region in the second direction, and L1a is a distance between the third surface and the first through-hole electrode in the second direction.

5. The multilayer electronic component of claim 1, wherein a ratio of L1b to L1 (L1b/L1) is 5% or more, where L1 is a length of the first margin region in the second direction, and L1b is a distance between the overlap region and the first through-hole electrode in the second direction.

6. The multilayer electronic component of claim 1, wherein D1 is 5 μm or more, where D1 is a diameter of the first through-hole electrode.

7. The multilayer electronic component of claim 3, wherein a ratio of D2 to D1 (D2/D1) is 1.2 or more, wherein D1 is a diameter of the first through-hole electrode and D2 is a distance between the plurality of the first through-electrodes.

8. The multilayer electronic component of claim 7, wherein a ratio of D2 to D1 (D2/D1) is 2.5 or less.

9. The multilayer electronic component of claim 1, wherein the first external electrode is disposed to extend from the third surface onto the first and second surfaces,
wherein the second external electrode is disposed to extend from the fourth surface onto the first and second surfaces,
wherein the first through-hole electrode is exposed to the first and second surfaces and connected to the first external electrode,
wherein the second through-hole electrode is exposed to the first and second surfaces and connected to the second external electrode.

10. The multilayer electronic component of claim 1, wherein the first internal electrode includes a first main portion disposed in the overlap region and overlapping the second internal electrode, and a first lead portion disposed in the first margin region and extending from the first main portion and exposed to the third surface,
wherein the second internal electrode includes a second main portion disposed in the overlap region and overlapping the first internal electrode, and a second lead portion disposed in the second margin region and extending from the second main portion and exposed to the fourth surface.

11. The multilayer electronic component of claim 1, wherein cross sections of the first and second through-hole electrodes are circular, in the cross section of the body in the second and third directions.

12. The multilayer electronic component of claim 1, wherein the first through-hole electrode is connected to a plurality of first lead portions and is spaced apart from the second internal electrode, and
wherein the second through-hole electrode is connected to a plurality of second lead portions and is spaced apart from the first internal electrode.
